(19) United States
(12) Patent Application Publication
(10) Pub. No.: US 2025/0220182 A1
(43) Pub. Date: Jul. 3, 2025

(54) METHOD AND DEVICE FOR COMPRESSING FEATURE TENSOR ON BASIS OF NEURAL NETWORK

(71) Applicant: INTELLECTUAL DISCOVERY CO., LTD., Seoul (KR)

(72) Inventors: Yongjo AHN, Seoul (KR); Jongseok LEE, Seoul (KR)

(21) Appl. No.: 18/848,036

(22) PCT Filed: Mar. 20, 2023
(86) PCT No.: PCT/KR2023/003661

§ 371 Date: Sep. 17, 2024

(30) Foreign Application Priority Data
Mar. 18, 2022 (KR) 10-2022-0033790
Mar. 18, 2022 (KR) 10-2022-0033791

(51) Int. Cl. H04N 19/124; G06V 10/77; G06V 10/82; H04N 19/13; H04N 19/169; H04N 19/189

(52) U.S. Cl. CPC H04N 19/124; G06V 10/7715; G06V 10/82; H04N 19/13; H04N 19/169; H04N 19/189

(57) ABSTRACT

A method and a device for processing an image on the basis of a neural network, according to an embodiment of the present invention, can acquire a feature tensor from an input image by using a first neural network including a plurality of neural network layers, acquire a quantized feature tensor by quantizing the acquired feature tensor on the basis of the quantization size, and generate a bitstream by performing entropy encoding on the quantized feature tensor.

### TECHNICAL FIELD

The present invention relates to a method and a device for compressing a feature tensor, and more specifically, to a method and a device for compressing a feature tensor by using video compression.

### BACKGROUND ART

Video images are compressed and encoded by removing spatial-temporal redundancy and inter-view redundancy and can be transmitted through communication lines or stored in a suitable form on a storage medium.

### DISCLOSURE

### Technical Problem

The present invention proposes a method and a device for compressing a feature tensor that is an intermediate result of a neural network based on a backpropagation algorithm.

The present invention proposes a method and a device for performing quantization on a transform block by using a quantization matrix obtained from a feature tensor by using a neural network.

### Technical Solution

In order to solve the above problems, a method and a device for performing inference and image encoding/decoding using a neural network are provided. Additionally, to solve the above problems, an inference method and device using video compression are provided.

A method and a device for processing an image based on a neural network according to an embodiment of the present invention may acquire a feature tensor from an input image by using a first neural network including a plurality of neural network layers, acquire a quantized feature tensor by quantizing the acquired feature tensor based on a quantization size and generate a bitstream by performing entropy encoding on the quantized feature tensor.

In a method and a device for processing an image based on a neural network according to an embodiment of the present invention, the quantization size may be adaptively derived based on predefined encoding information.

In a method and a device for processing an image based on a neural network according to an embodiment of the present invention, the quantization size may be adaptively derived based on at least one of the acquired feature tensors, a target bit rate or distribution information.

In a method and a device for processing an image based on a neural network according to an embodiment of the present invention, the distribution information may be acquired based on a distribution feature tensor, and the distribution feature tensor may be acquired from the acquired feature tensor by using a second neural network including a plurality of neural network layers.

In a method and a device for processing an image based on a neural network according to an embodiment of the present invention, the bitstream may include a distribution bitstream generated by performing entropy encoding on the distribution feature tensor.

In a method and a device for processing an image based on a neural network according to an embodiment of the present invention, the quantization size may be derived by repeatedly updating the quantization size based on a backpropagated error, and the error may be derived based on a difference between the target bit rate and a prediction bit rate.

In a method and a device for processing an image based on a neural network according to an embodiment of the present invention, update for the quantization size may be repeatedly performed so that the prediction bit rate converges to the target bit rate.

In a method and a device for processing an image based on a neural network according to an embodiment of the present invention, update for the quantization size may be repeatedly performed so that the error becomes smaller than or equal to a predefined threshold value.

In a method and a device for processing an image based on a neural network according to an embodiment of the present invention, update for the quantization size may be performed by using at least one method of stochastic gradient descent, adaptive moment estimation or root mean square propagation.

In a method and a device for processing an image based on a neural network according to an embodiment of the present invention, the prediction bit rate may be calculated by using a probability value of values of the acquired feature tensor determined according to the distribution information.

In a method and a device for processing an image based on a neural network according to an embodiment of the present invention, the prediction bit rate may be calculated by adding a value obtained by taking a logarithm with a base of 2 to a probability value of values of the acquired feature tensor.

In a method and a device for processing an image based on a neural network according to an embodiment of the present invention, the error may be backpropagated by using a Straight Through Estimator (STE) method in which a differential value is fixed to a predefined value.

In a method and a device for processing an image based on a neural network according to an embodiment of the present invention, the differential value may be predefined as one of ½, 1, 2, 3 and 4.

In a method and a device for processing an image based on a neural network according to an embodiment of the present invention, the bitstream may be generated by performing Asymmetric Numeral System (ANS)-based entropy encoding on the quantized feature tensor based on a predefined probability table.

In a method and a device for processing an image based on a neural network according to an embodiment of the present invention, the first neural network and the second neural network may be learned so that the sum of a difference between the input image and a reconstructed image and the amount of generated bits becomes smaller.

### Technical Effect

Video signal coding efficiency may be improved through a feature tensor compression method and device according to the present invention.

In addition, video signal coding efficiency may be improved through a neural network-based residual data compression method and device according to the present invention.

In addition, the encoding efficiency of feature map compression may be improved by determining a quantization size for a feature tensor based on a backpropagation algorithm proposed in the present invention.

In addition, encoding efficiency may be improved by performing quantization for a transform block by using a quantization matrix acquired from a feature tensor by using a neural network proposed in the present invention.

### DESCRIPTION OF DRAWINGS

FIG. 1 is a block diagram showing an example of a neural network-based image encoder and decoder according to an embodiment of the present invention.

FIG. 2 is a block diagram showing an example of a neural network-based image encoder using a distribution encoder according to an embodiment of the present invention.

FIG. 3 is a block diagram showing an example of a neural network-based image decoder using a distribution decoder according to an embodiment of the present invention.

FIG. 4 is a block diagram showing an example of a neural network-based image encoder for rate control according to an embodiment of the present disclosure.

FIG. 5 is a block diagram showing an example of a neural network-based image decoder for rate control according to an embodiment of the present disclosure.

FIG. 6 is a block diagram showing an example of a residual encoder according to an embodiment of the present invention.

FIG. 7 is a block diagram showing an example of a residual decoder according to an embodiment of the present invention.

FIG. 8 is a block diagram showing an example of a residual encoder using a neural network-based quantization matrix.

FIG. 9 is a block diagram showing an example of a residual decoder using a neural network-based quantization matrix.

FIG. 10 is a flowchart showing a neural network-based image processing method according to an embodiment of the present invention.

### BEST MODE

A method and a device for processing an image based on a neural network according to an embodiment of the present invention may acquire a feature tensor from an input image by using a first neural network including a plurality of neural network layers, acquire a quantized feature tensor by quantizing the acquired feature tensor based on a quantization size and generate a bitstream by performing entropy encoding on the quantized feature tensor.

In a method and a device for processing an image based on a neural network according to an embodiment of the present invention, the quantization size may be adaptively derived based on predefined encoding information.

In a method and a device for processing an image based on a neural network according to an embodiment of the present invention, the quantization size may be adaptively derived based on at least one of the acquired feature tensor, a target bit rate, or distribution information.

In a method and a device for processing an image based on a neural network according to an embodiment of the present invention, the distribution information may be acquired based on a distribution feature tensor, and the distribution feature tensor may be acquired from the acquired feature tensor by using a second neural network including a plurality of neural network layers.

In a method and a device for processing an image based on a neural network according to an embodiment of the present invention, the bitstream may include a distribution bitstream generated by performing entropy encoding on the distribution feature tensor.

In a method and a device for processing an image based on a neural network according to an embodiment of the present invention, the quantization size may be derived by repeatedly updating the quantization size based on a backpropagated error, and the error may be derived based on a difference between the target bit rate and a prediction bit rate.

In a method and a device for processing an image based on a neural network according to an embodiment of the present invention, update for the quantization size may be repeatedly performed so that the prediction bit rate converges to the target bit rate.

In a method and a device for processing an image based on a neural network according to an embodiment of the present invention, update for the quantization size may be repeatedly performed so that the error becomes smaller than or equal to a predefined threshold value.

In a method and a device for processing an image based on a neural network according to an embodiment of the present invention, update for the quantization size may be performed by using at least one method of stochastic gradient descent, adaptive moment estimation, or root mean square propagation.

In a method and a device for processing an image based on a neural network according to an embodiment of the present invention, the prediction bit rate may be calculated by using a probability value of values of the acquired feature tensor determined according to the distribution information.

In a method and a device for processing an image based on a neural network according to an embodiment of the present invention, the prediction bit rate may be calculated by adding a value obtained by taking a logarithm with a base of 2 to a probability value of values of the acquired feature tensor.

In a method and a device for processing an image based on a neural network according to an embodiment of the present invention, the error may be backpropagated by using a Straight Through Estimator (STE) method in which a differential value is fixed to a predefined value.

In a method and a device for processing an image based on a neural network according to an embodiment of the present invention, the differential value may be predefined as one of ½, 1, 2, 3, or 4.

In a method and a device for processing an image based on a neural network according to an embodiment of the present invention, the bitstream may be generated by performing Asymmetric Numeral System (ANS)-based entropy encoding on the quantized feature tensor based on a predefined probability table.

In a method and a device for processing an image based on a neural network according to an embodiment of the present invention, the first neural network and the second neural network may be learned so that the sum of a difference between the input image and a reconstructed image and the amount of generated bits becomes smaller.

### Mode

An embodiment of the present disclosure will be described in detail so that those skilled in the art may easily implement it by referring to a drawing attached to this specification. But, the present disclosure may be implemented in different forms and it is not limited to an embodiment described herein. And, a part irrelevant to a description is omitted to clearly describe the present disclosure in a drawing and a similar reference numeral is attached to a similar part throughout this specification.

Throughout this specification, when a part is referred to as being ‘connected’ to other part, it may include an electrical connection that other element presents therebetween as well as a direct connection.

In addition, when a part is referred to as ‘including’ a component throughout this specification, it means other component may be further included without excluding other component unless otherwise opposed.

In addition, a term such as first, second, etc. may be used to describe a variety of components, but the components should not be limited by the terms. The terms are used only to distinguish one component from other component.

In addition, for an embodiment about a device and a method described in this specification, some configurations of a device or some steps of a method may be omitted. In addition, order of some configurations of a device or some steps of a method may be changed. In addition, other configuration or other step may be inserted into some configurations of a device or some steps of a method.

In addition, some configurations or some steps of a first embodiment of the present disclosure may be added to a second embodiment of the present disclosure or may substitute some configurations or some steps of a second embodiment.

In addition, construction units shown in an embodiment of the present disclosure are independently shown to represent different characteristic functions, and they do not mean that each construction unit is configured with separated hardware or one software construction unit. In other words, each construction unit is described by being enumerated as each construction unit for convenience of a description and at least two construction units of each construction unit may be combined to form one construction unit or one construction unit may be partitioned into a plurality of construction units to perform a function. An integrated embodiment and separated embodiment of each construction unit are also included in a scope of a right of the present disclosure unless they are departing from the spirit of the present disclosure.

First, terms used in this application may be briefly described as follows.

A decoding device (Video Decoding Apparatus) to be described later may be a device included in a server terminal such as a civil security camera, a civil security system, a military security camera, a military security system, a personal computer (PC), a notebook computer, a portable multimedia player (PMP), a wireless communication terminal, a smart phone, a TV application server and a service server, etc. and it may mean a variety of devices equipped with a user terminal including equipment of every kind, a communication device including a communication modem, etc. for communication with a wired/wireless communication network, a memory for storing various kinds of programs and data for decoding an image or performing intra or inter prediction for decoding, a microprocessor for executing a program and performing operation and control and others.

In addition, an image encoded as a bitstream by an encoder may be transmitted to an image decoding device, decoded and reconstructed and reproduced as an image through a variety of communication interface such as a cable, an universal serial bus (USB), etc. or through a wired or wireless communication network, etc. such as the Internet, a wireless local area network, a wireless LAN network, a Wi-Bro network, a mobile communication network, etc. in real time or in non-real time. Alternatively, a bitstream generated by an encoder may be stored in a memory. The memory may include both a volatile memory and a non-volatile memory. In this specification, a memory may be expressed as a recoding medium storing a bitstream.

Commonly, a video may be configured with a series of pictures and each picture may be partitioned into coding units like a block. In addition, a person with ordinary skill in the art to which this embodiment pertains may understand that a term of picture entered below may be used by being substituted with other term having the same meaning as an image, a frame, etc. And, a person with ordinary skill in the art to which this embodiment pertains may understand that a term of coding unit may be used by being substituted with other term having the same meaning as a unit block, a block, etc.

Hereinafter, in reference to attached drawings, an embodiment of the present disclosure is described in more detail. In describing the present disclosure, an overlapping description is omitted for the same component.

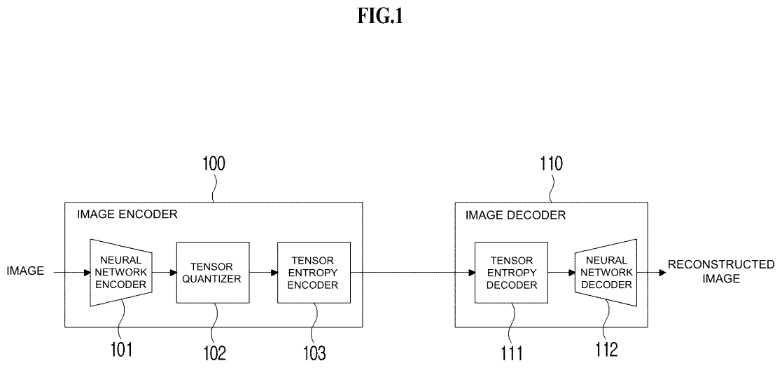

FIG. 1 is a block diagram showing an example of a neural network-based image encoder and decoder according to an embodiment of the present invention.

Referring to FIG. 1, a neural network-based image encoder (100) according to an embodiment of the present invention may include a neural network encoder (101), a tensor quantizer (102) and a tensor entropy encoder (103). A neural network-based image decoder (110) according to an embodiment of the present invention may include a tensor entropy decoder (111) and a neural network decoder (112).

A neural network-based image encoder (101) may receive an image as input and generate a bitstream.

A neural network encoder (101) may receive an image as input and generate a feature tensor through multiple neural network layers. Here, a feature tensor may refer to one-dimensional data or higher generated from a neural network. In addition, one or more feature tensors may be output. In the present disclosure, a feature tensor may represent a feature map. Alternatively, at least one feature tensor output from a neural network may be referred to as a feature map. In this case, an input image may be data such as an image, a video, a point cloud and a mesh and may be an image that is pre-processed before being input to a neural network encoder (101). A neural network encoder (101) may include at least one neural network.

In an embodiment, each neural network may include multiple neural network layers. In this case, the neural network layers may include at least one of a convolution layer, a deconvolution layer, a transposed convolution layer, a dilated convolution layer, a grouped convolution layer, a graph convolution layer, an average pooling layer, a max pooling layer, an up sampling layer, a down sampling layer, a pixel shuffle layer, a channel shuffle layer, a batch normalization layer, a weight normalization layer, or a generalized normalization layer.

As an example, a neural network layer may be a layer that performs a convolution operation, such as a convolution layer, a transposed convolution layer, a grouped convolution layer, a graph convolution layer, etc. Alternatively, a neural network layer may refer to an activation function such as sigmoid, ReLU (Rectified Linear Unit), etc. Alternatively, the neural network layer may be a layer that performs general operations such as summation, subtraction, and multiplication. Alternatively, the neural network layer may be a batch normalization layer, a weight normalization layer, or a generalization normalization layer that normalizes the tensor. Alternatively, the neural network layer may be a layer such as upsampling or downsampling. Alternatively, the neural network layer may be a pooling layer or an activation layer.

Neural networks may generally be used in a variety of applications such as image classification, image recontruction, image partition, object recognition, and object tracking. Therefore, the neural network according to this embodiment may be learned to receive images as input and infer results suitable for each application.

In this case, a neural network encoder (101) may be a neural network encoder (101) that is learned through joint optimization with a neural network decoder (112) during a learning process so that the sum of a difference between an input image and a reconstructed image and/or the amount of bits generated is reduced. A generated feature tensor may be transmitted to a tensor quantizer (102).

In one embodiment of the present invention, at least one neural network included in a neural network encoder (101) may include a graph convolution layer. The convolution layer may extract features of the image and generate (or update) a feature map based on the extracted features. The graph convolution layer represents a convolution layer that extracts features based on graph data. Graph data may include a plurality of node information (vertex information) and/or connection information between a plurality of nodes (edge information). As an example, a wavelet transform may be used in the graph convolution layer. As an example, a graph-based wavelet transform may be used in a graph convolution layer. Graph-based wavelet transform may be referred to as lifting transform. As an example, the first neural network may use wavelet transform and lifting transform, and the second neural network may use inverse wavelet transform and inverse lifting transform.

A tensor quantizer (102) may receive a feature tensor as input and perform quantization to generate a quantized feature tensor. As an example, a rounding operation may be performed as quantization. Alternatively, a rounding-down operation may be performed as quantization. A generated quantized feature tensor may be transmitted to a tensor entropy encoder (103).

A tensor entropy encoder (103) may generate a bitstream by entropy encoding an input quantized feature tensor. In addition, information necessary for reconstruction such as a width, a height, the number of channels, etc. of an input feature tensor may be encoded together. In this case, Context-Adaptive Binary Arithmetic Coding (CABAC) may be used for entropy encoding. Alternatively, Arithmetic Coding (AC) using a multi-symbol may be used. Alternatively, as an example, Asymmetric Numeral System (ANS)-based entropy encoding may be performed. ANS is an entropy coding method that codes multiple symbols into an integer with high encoding efficiency and generates a bitstream by binarizing a corresponding integer. An ANS process may be performed by multiplying an integer value of a current state by using an integer value of a reciprocal of a probability value of each symbol. This ANS process is very simple compared to the entropy coding technology used in the conventional compression technology and accordingly, has low computational complexity. As an example, ANS-based entropy encoding for a symbol (or a coefficient) of a quantized feature tensor may be performed based on a predefined probability table.

In addition, a tensor entropy encoder (102) may generate and use the distribution of an input quantized feature tensor by using multiple parameters learned in a learning process. In this case, a different parameter for generating a distribution may be used in a unit of a channel. A generated bitstream may be transmitted to an image decoder (110).

An image decoder (110) may receive a bitstream as input, reconstruct an image and generate a reconstructed image.

A tensor entropy decoder (111) may receive a bitstream as input and reconstruct a feature tensor. In this case, a CABAC decoder may be used in an entropy decoder (111). An ANS-based entropy decoder may be used. Alternatively, an ANS decoder using multiple symbols may be used. For example, if an ANS-based entropy decoder was used, a tensor entropy decoder (111) may generate a distribution by using multiple parameters learned as in a tensor entropy encoder (103) and use it to perform ANS-based entropy decoding. A reconstructed feature tensor may be transmitted to a neural network decoder (112).

A neural network decoder (112) may use an input feature tensor to reconstruct an image through multiple neural network layers. As described above, a neural network decoder (112) may be a neural network decoder that is learned through joint optimization with a neural network encoder (101) during a learning process so that the sum of a difference between an input image and a reconstructed image and the amount of bits generated is reduced.

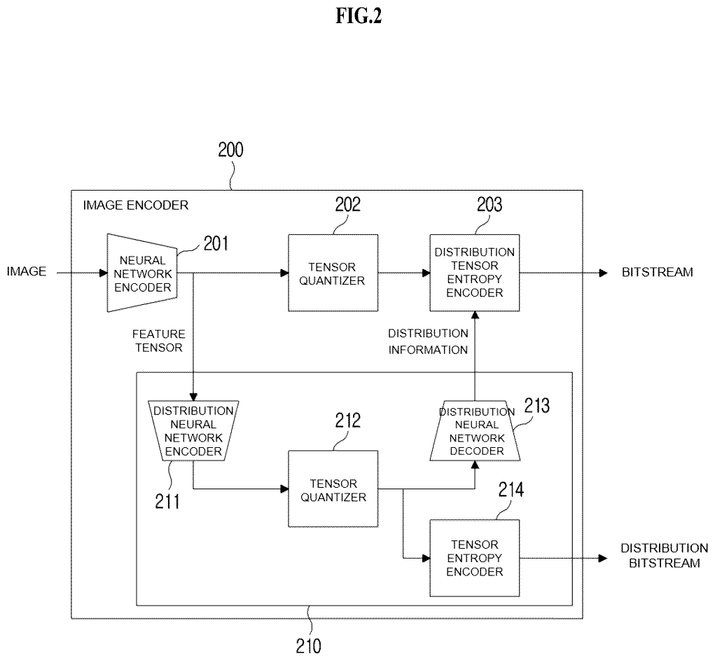

FIG. 2 is a block diagram showing an example of a neural network-based image encoder using a distribution encoder according to an embodiment of the present invention.

Referring to FIG. 2, a neural network-based image encoder (200) may include a neural network encoder (201), a tensor quantizer (202), a distribution tensor entropy encoder (203) and a distribution encoder (210). A neural network-based image encoder (200) may be an example of a neural network-based image encoder (100) described above in FIG. 1. An embodiment described above in FIG. 1 may be applied in the same manner, and an overlapping description related thereto is omitted.

A neural network-based image encoder (200) may receive an image as input and generate a bitstream.

Specifically, a neural network encoder (201) may receive an image as input and generate a feature tensor through multiple neural network layers. A generated feature tensor may be transmitted to a tensor quantizer (202). In addition, a generated feature tensor may be transmitted to a distribution encoder (210).

A tensor quantizer (202) may receive a feature tensor as input and perform quantization to generate a quantized feature tensor. A generated quantized feature tensor may be transmitted to a distribution tensor entropy encoder (203). In the present disclosure, a name of a configuration according to an embodiment is not limited thereto. For example, a distribution tensor entropy encoder (203) may be referred to as a tensor entropy encoder or a feature tensor entropy encoder.

A distribution encoder (210) may receive a feature tensor as input and generate distribution information and/or a distribution bitstream. A distribution encoder (210) may include a distribution neural network encoder (211), a tensor quantizer (212), a distribution neural network decoder (213) and a tensor entropy encoder (214).

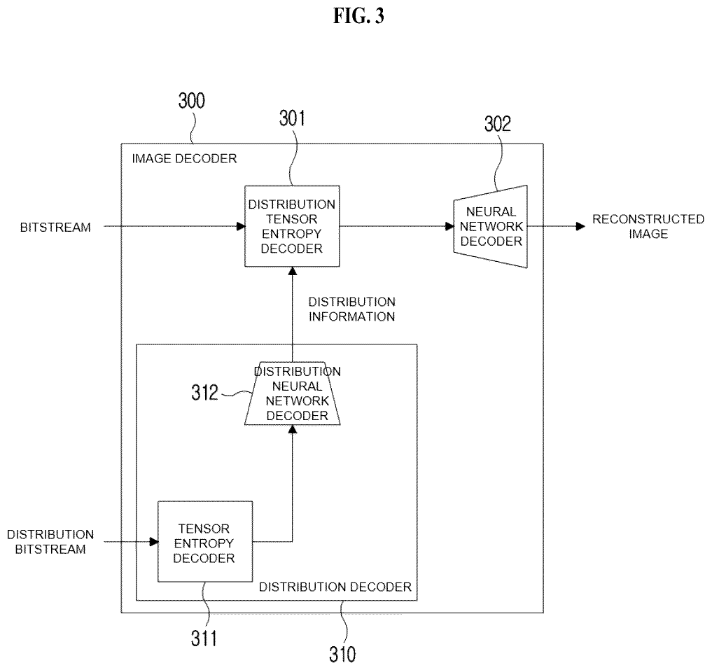

A distribution neural network encoder (211) may use an input feature tensor to generate a distribution feature tensor through multiple neural network layers. In this case, a distribution neural network encoder (211) may be a neural network learned through joint optimization with a neural network encoder (201), a neural network decoder (302 in FIG. 3) and a distribution neural network decoder (302) in a learning step so that a difference evaluation value for image quality between an input image and a reconstructed image and a prediction value for the amount of generated bits are reduced. A generated distribution feature tensor may be transmitted to a tensor quantizer (212).

A tensor quantizer (212) may quantize an input distribution feature tensor to generate a quantized distribution feature tensor. A generated distribution feature tensor may be transmitted to a distribution neural network decoder (213) and a tensor entropy encoder (214).

A tensor entropy encoder (214) may entropy-encode an input distribution feature tensor to generate a distribution bitstream.

A distribution neural network decoder (213) may receive a distribution feature tensor as input and generate distribution information through multiple neural network layers. In this case, distribution information may be multiple parameters for expressing a specific probability distribution. For example, for a Gaussian distribution, an average and a standard deviation may be a parameter. In this case, an average and a standard deviation may have the same width, height and channel length as a feature tensor, respectively. In other words, a distribution neural network decoder (213) may generate each distribution parameter for a value of a feature tensor. Generated distribution information may be transmitted to a distribution tensor entropy encoder (203).

A distribution tensor entropy encoder (203) may generate a bitstream by performing entropy encoding on an input quantized feature tensor and distribution information. In addition, information necessary for reconstruction such as a width, a height, the number of channels, etc. of an input feature tensor may be encoded together. In this case, an ANS encoder using multiple symbols may be used. For example, ANS-based entropy encoding may be performed. Here, a probability value for each value of a quantized feature tensor may be calculated based on input distribution information, and ANS-based entropy encoding may be performed by using this. A generated bitstream may be transmitted to an image decoder.

FIG. 3 is a block diagram showing an example of a neural network-based image decoder using a distribution decoder according to an embodiment of the present invention.

Referring to FIG. 3, a neural network-based image decoder (300) may include a distribution tensor entropy decoder (301), a neural network decoder (302) and a distribution decoder (310). A neural network-based image decoder (300) may be an example of a neural network-based image decoder (110) described above in FIG. 1. An embodiment described above in FIG. 1 may be applied in the same manner, and an overlapping description related thereto is omitted.

An image decoder (300) may receive a bitstream as input, reconstruct an image and generate a reconstructed image.

Specifically, a distribution decoder (310) may receive a distribution bitstream as input and generate distribution information. A distribution decoder (310) may include a tensor entropy decoder (311) and a distribution neural network decoder (312).

A tensor entropy decoder (311) may generate a distribution feature tensor by entropy decoding an input distribution bitstream.

A distribution neural network decoder (312) may receive a distribution feature tensor as input and generate distribution information through multiple neural network layers. Generated distribution information may be transmitted to a distribution tensor entropy decoder (301).

A distribution tensor entropy decoder (301) may receive a bitstream as input and reconstruct a feature tensor. In this case, an ANS decoder using multiple symbols may be used. For example, an ANS-based entropy decoder may be used. If an ANS-based entropy decoder was used, a distribution may be generated by using multiple parameters learned as in a tensor entropy encoder, and ANS-based entropy decoding may be performed by using this. A reconstructed feature tensor may be transmitted to a neural network decoder (302).

A neural network decoder (302) may use an input feature tensor to reconstruct an image through multiple neural network layers. In this case, a neural network decoder (302) may be a neural network decoder learned through joint optimization with a neural network encoder during a learning process so that the sum of a difference between an input image and a reconstructed image and the amount of bits generated is reduced.

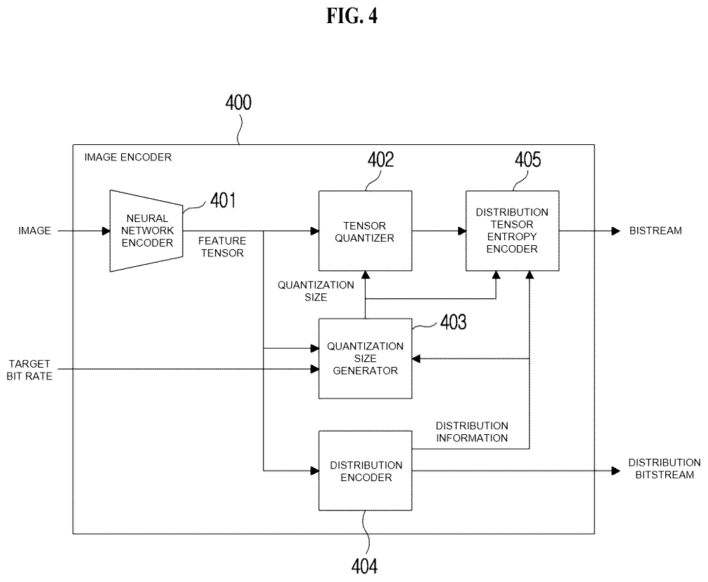

FIG. 4 is a block diagram showing an example of a neural network-based image encoder for rate control according to an embodiment of the present disclosure.

Referring to FIG. 4, a neural network-based image encoder (400) for rate control may include a neural network encoder (401), a tensor quantizer (402), a quantization size generator (403), a distribution encoder (404) and a distribution tensor entropy encoder (405). A neural network-based image encoder (400) for rate control according to this embodiment may be an example of a neural network-based image encoder (100, 200) described above in FIGS. 1 and 2. An embodiment described above in FIGS. 1 and 2 may be applied in the same manner, and an overlapping description related thereto is omitted.

A neural network-based image encoder (400) for rate control may receive an image and/or a target bit rate as input and generate a bitstream and/or a distribution bitstream.

Specifically, a neural network encoder (401) may receive an image as input and generate a feature tensor through multiple neural network layers. A generated feature tensor may be transmitted to a distribution encoder (404), a quantization size generator (403) and a tensor quantizer (402).

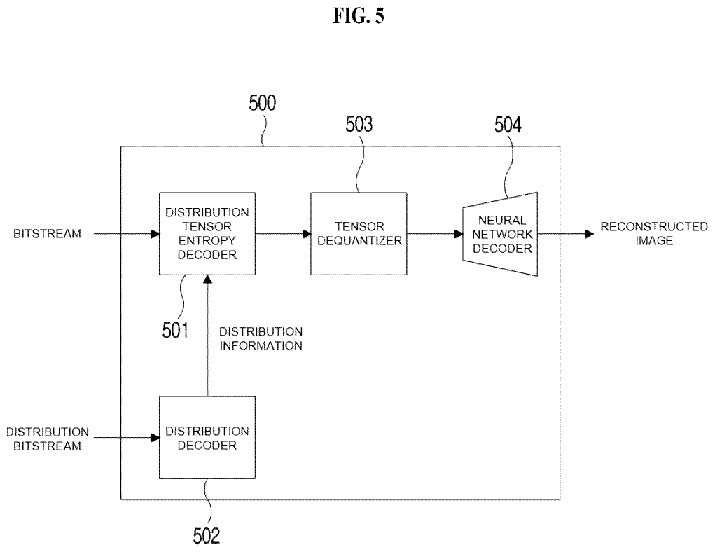

A distribution encoder (404) may receive a feature tensor as input and encode it to generate a distribution bitstream and simultaneously generate distribution information of a feature tensor. A generated distribution bitstream may be transmitted to an image decoder (500 of FIG. 5). In addition, distribution information may be transmitted to a quantization size generator (403) and a distribution tensor entropy encoder (405).

A quantization size generator (403) may adaptively generate (or determine) a quantization size based on predefined encoding information. A quantization size may be determined explicitly or implicitly. As an example, a quantization size generator (403) may generate a quantization size according to a target bit rate based on at least one of a feature tensor, a target bit rate and distribution information.

According to an embodiment of the present invention, a quantization size may be generated (or determined, updated) through a backpropagation process. In other words, an error may be derived based on a difference between a target bit rate and a prediction bit rate, and a quantization size may be generated by backpropagating a derived error. As an example, a quantization size generator (403) may divide a feature tensor by a quantization size and perform a rounding operation in order to calculate a prediction bit rate. In other words, a quantization size generator (403) may perform quantization on a feature tensor based on an initial quantization size. A quantization size generator (403) may calculate a prediction bit rate by dividing a feature tensor by an initial quantization size and performing a rounding operation. When a quantization size is updated recursively or repeatedly, the initial quantization size may be a quantization size updated through an updated backpropagation process. In an example, a feature tensor to which a division operation is applied based on a quantization size may be a coefficient, a symbol or a sample of a feature tensor.

In an embodiment, since the distribution of a feature tensor is changed by a quantization size, distribution information may be scaled based on a quantization size to reflect this. For example, when a distribution is a Gaussian distribution, a quantization size generator (403) may divide at least one of an average or a standard deviation that are distribution information by a quantization size and calculate a probability value of a feature tensor. Afterwards, a quantization size generator (403) may calculate a prediction bit rate based on a probability values of feature tensor values. For example, a quantization size generator (403) may calculate a prediction bit rate by taking a logarithm with a base of 2 and adding it to a probability value of feature tensor values.

As described above, a quantization size generator (403) may backpropagate an error by using a difference between a prediction bit rate and a target bit rate as an error in order to update a quantization size. As an example, an error value may be an absolute value of a difference between a prediction bit rate and a target bit rate. Alternatively, as an example, an error value may be an average value of an absolute value of a difference between a prediction bit rate and a target bit rate. Alternatively, as an example, an error value may be an average value of a square of a difference between a prediction bit rate and a target bit rate.

In addition, since a rounding operation in a backpropagation process is an operation that may not be differentiated, a quantization size generator (403) may backpropagate an error through Straight Through Estimator (STE). STE may refer to a method in which differentiation is impossible, but a differential value is fixed to a predefined value and backpropagated. For example, the predefined value may be defined as a value such as 0.5, 1, 2, 3, 4, etc. A quantization size generator (403) may update a quantization size by using a variance in a quantization size for an error variance which is a differential value obtained through a backpropagation algorithm.

In an embodiment, a quantization size may be updated through Stochastic Gradient Descent. Alternatively, a deep learning-based optimization method such as Adaptive Moment Estimation (Adam), Root Mean Square Propagation (RMSProp), etc. may be used.

A prediction bit rate may be calculated again by using an updated quantization size, and an error may be calculated based on this. A calculated error may be backpropagated and a quantization size may be repeatedly updated to optimize a quantization size so that a prediction bit rate is similar to a target bit rate. In an embodiment, the above-described backpropagation process may be repeatedly performed so that an error is less than or equal to a predefined threshold.

An optimized quantization size may be transmitted to a tensor quantizer (402) and a distribution tensor entropy encoder (405).

A tensor quantizer (402) may perform quantization by using an input feature tensor and an optimized quantization size. In this case, quantization may refer to a process of dividing a feature tensor by a quantization size. A quantized feature tensor may be transmitted to a distribution tensor entropy encoder (405).

A distribution tensor entropy encoder (405) may receive a quantized feature tensor, a quantization size and distribution information as input and generate a bitstream through entropy encoding. In addition, a quantization size may be entropy-encoded, included in a bitstream and transmitted to an image decoder (500 of FIG. 5). In addition, the width, height and channel length values of a feature tensor may be entropy-encoded, included in a bitstream and transmitted to an image decoder (500 of FIG. 5).

In this case, distribution information used to calculate the probability value of feature tensor values to be used for entropy encoding may be scaled by using a quantization size. As a quantized feature tensor is scaled to a quantization size in a quantization step, a distribution is changed, so distribution information expressing a distribution also needs to be scaled. For example, when a distribution is a Gaussian distribution, an average and a standard deviation that are distribution information may be divided by a quantization size. A generated bitstream may be transmitted to an image decoder (500 of FIG. 5).

FIG. 5 is a block diagram showing an example of a neural network-based image decoder for rate control according to an embodiment of the present disclosure.

Referring to FIG. 5, a neural network-based image decoder (500) for rate control may include a distribution tensor entropy decoder (501), a distribution decoder (502), a tensor dequantizer (503) and a neural network decoder (504). A neural network-based image decoder (500) for rate control according to this embodiment may be an example of a neural network-based image encoder (100, 300) described above in FIGS. 1 and 3. An embodiment described above in FIGS. 1 and 3 may be applied in the same manner, and an overlapping description related thereto is omitted.

An image decoder (500) may receive a bitstream and a distribution bitstream as input and reconstruct an image.

A distribution decoder (502) may receive a distribution bitstream as input and generate distribution information. Generated distribution information may be transmitted to a distribution tensor entropy decoder (501).

A distribution tensor entropy decoder (501) may perform entropy decoding by using an input bitstream and distribution information to reconstruct a quantized feature tensor. In this case, a distribution tensor entropy decoder (501) may reconstruct a quantization size from a bitstream.

In this case, distribution information may be scaled by using a reconstructed quantization size, and a quantized feature tensor may be reconstructed by performing entropy decoding with scaled distribution information.

A generated quantization size and a reconstructed quantized feature tensor may be transmitted to a tensor dequantizer (503).

A tensor dequantizer (503) may perform dequantization by using an input quantization size and a reconstructed quantized feature tensor to generate a reconstructed feature tensor. In this case, a dequantization process may perform an operation of multiplying a quantized feature tensor by a quantization size. A reconstructed feature tensor may be transmitted to a neural network decoder (504).

A neural network decoder (504) may receive a reconstructed feature tensor as input and reconstruct an image through multiple neural network layers. In this case, a neural network decoder (504) may be a neural network learned through joint optimization with a neural network encoder (400 of FIG. 4) of an image encoder (400 of FIG. 4) and the neural networks of a distribution encoder/decoder.

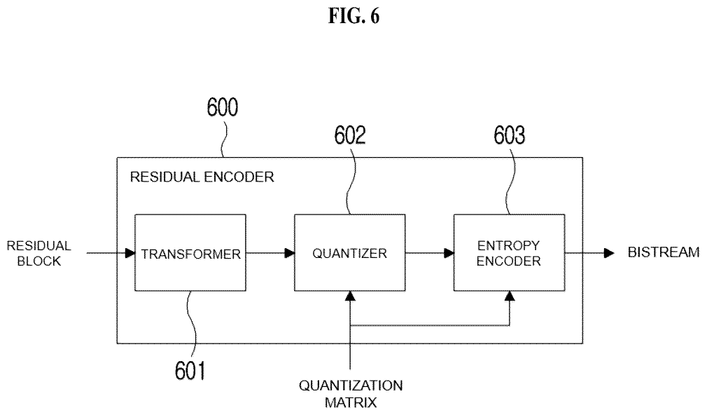

FIG. 6 is a block diagram showing an example of a residual encoder according to an embodiment of the present invention.

Referring to FIG. 6, a residual encoder (600) may include a transformer (601), a quantizer (602) and an entropy encoder (603).

A residual encoder (600) may receive a residual block (or a transform block) as input and perform encoding to generate a bitstream. The present disclosure mainly describes a case in which the input of a residual encoder (600) is residual data obtained by subtracting a predicted image from an original image, but the present disclosure is not limited thereto. For example, the input of a residual encoder (600) may be the same as the input of an image encoder described above in FIGS. 1 to 5. As an example, the input of a residual encoder (600) may be image data.

Specifically, a transformer (601) may receive a current residual block as input and perform transform to generate a transform block. A generated transform block may be transmitted to a quantizer (602).

A quantizer (602) may perform quantization by using an input transform block and a quantization matrix to generate a quantized transform block. A quantization matrix may be a predefined value or may be adaptively determined according to encoding information. A generated quantized transform block may be transmitted to an entropy encoder (603). In addition, a quantization matrix may be transmitted to an entropy encoder (603), entropy-encoded, included in a bitstream and transmitted to a decoder.

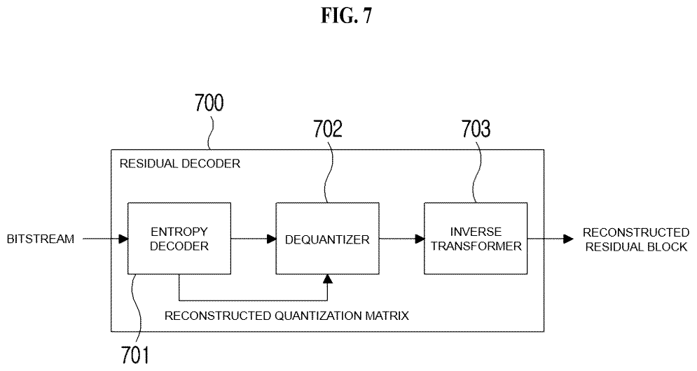

An entropy encoder (603) may generate a bitstream by entropy encoding an input quantized transform block. A generated bitstream may be transmitted to a residual decoder described in FIG. 7 below.

FIG. 7 is a block diagram showing an example of a residual decoder according to an embodiment of the present invention.

Referring to FIG. 7, a residual decoder (700) may include an entropy decoder (701), a dequantizer (702) and an inverse transformer (703).

A residual decoder (700) may receive a bitstream transmitted from a residual encoder (600 of FIG. 6) to reconstruct a residual block.

Specifically, an entropy decoder (701) may entropy decode an input bitstream to reconstruct a quantized transform block. In addition, an entropy decoder (701) may reconstruct a quantization matrix. A reconstructed and quantized transform block and a quantization matrix may be transmitted to a dequantizer (702).

A dequantizer (702) may perform dequantization by using a transmitted reconstructed and quantized transform block and a reconstructed quantization matrix to generate a dequantized transform block. A dequantized transform block may be transmitted to an inverse transformer (703).

An inverse transformer (703) may receive a dequantized transform block as input and perform inverse transform to reconstruct a residual block.

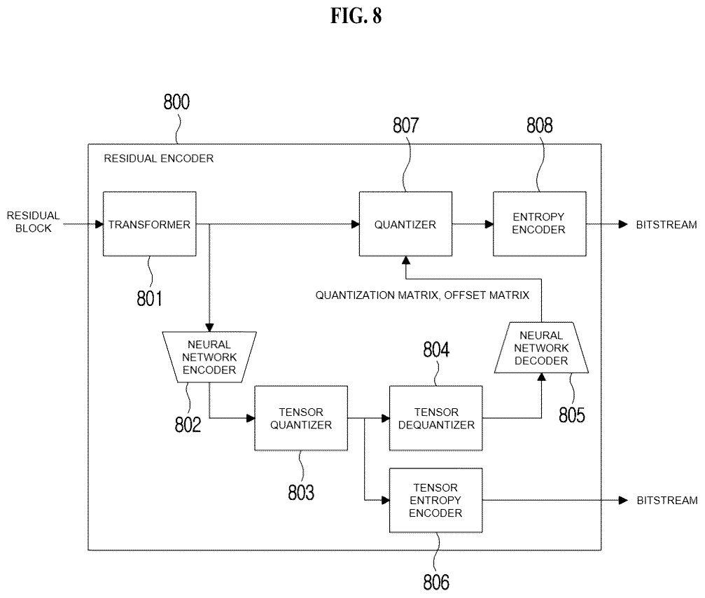

FIG. 8 is a block diagram showing an example of a residual encoder using a neural network-based quantization matrix.

Referring to FIG. 8, a residual encoder (800) may include a transformer (801), a neural network encoder (802), a tensor quantizer (803), a tensor dequantizer (804), a neural network decoder (805), a tensor entropy encoder (806), a quantizer (807) and an entropy encoder (808). A residual encoder (800) may be an example of a residual encoder (600) described above in FIG. 6. An embodiment described above in FIG. 6 may be applied in the same manner, and an overlapping description related thereto is omitted.

A residual encoder (800) may receive a residual block as input and generate one or more bitstreams.

A transformer (801) may receive a residual block as input and perform transform to generate a transform block. A generated transform block may be transmitted to a quantizer (807). In addition, a generated transform block may be transmitted to a neural network encoder (802).

A neural network encoder (802) may receive a transform block as input and analyze a transform block through one or more neural network layers to generate a feature tensor. A generated feature tensor may be transmitted to a tensor quantizer (803).

A tensor quantizer (803) may quantize an input feature tensor to generate a quantized feature tensor. In an embodiment, a method described above in FIGS. 1 to 5 may be applied as a tensor quantization method. Alternatively, as an example, rounding may be performed by a tensor quantization method. A generated quantized feature tensor may be transmitted to a tensor dequantizer (804). In addition, it may be transmitted to a tensor entropy encoder (806).

A tensor dequantizer (804) may dequantize an input quantized feature tensor to reconstruct a feature tensor. In this case, if quantization was performed through rounding in a tensor quantizer, dequantization may not be performed. A reconstructed feature tensor may be transmitted to a neural network decoder (805).

A neural network decoder (805) may receive a reconstructed feature tensor as input and synthesize features through multiple neural networks to generate a quantization matrix and/or an offset matrix. In this case, a quantization matrix and/or an offset matrix may have the same width and height as a reconstructed transform block. Alternatively, a quantization matrix and/or an offset matrix may be generated in a size smaller than a transform block in a width and a height. In this case, interpolation may be performed to be the same size as a transform block. In this case, various interpolation methods such as nearest interpolation, linear interpolation, etc. may be used. A generated quantization matrix and/or offset matrix may be transmitted to a quantizer (807).

A tensor entropy encoder (806) may generate a bitstream by entropy encoding an input quantized feature tensor.

A quantizer (807) may perform quantization by using an input transform block, a quantization matrix and an offset matrix to generate a quantized transform block. In this case, a quantization unit (807) may add or subtract a transform block and an offset matrix and scale them by using a quantization matrix. Scaling may be performed by using a value determined through a quantization parameter, a size of a transform block, a bit depth, etc. A quantized transform block may be transmitted to an entropy encoder (808).

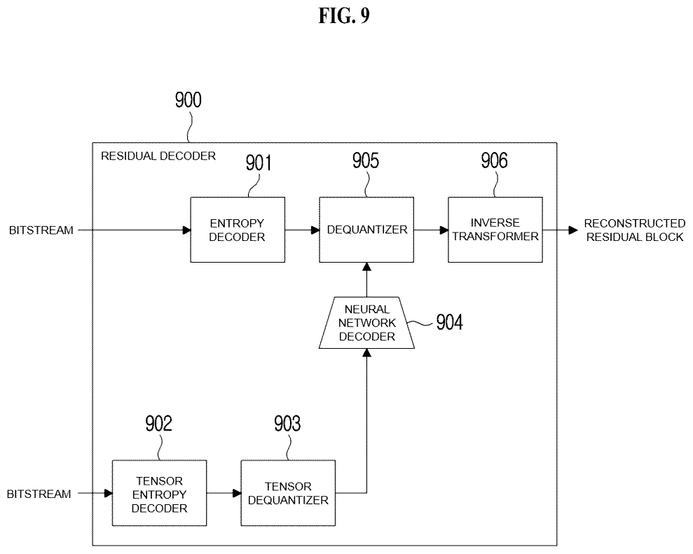

An entropy encoder (808) may entropy encode an input quantized transform block to generate a bitstream. A generated bitstream may be transmitted to a residual decoder described in FIG. 9 below.

FIG. 9 is a block diagram showing an example of a residual decoder using a neural network-based quantization matrix.

Referring to FIG. 9, a residual decoder (900) may include an entropy decoder (901), a tensor entropy decoder (902), a tensor dequantizer (903), a neural network decoder (904), a dequantizer (905) and an inverse transformer (906). A residual decoder (900) may be an example of a residual decoder (700) described above in FIG. 7. An embodiment described above in FIG. 7 may be applied in the same manner, and an overlapping description related thereto is omitted.

A residual decoder (900) may decode a transmitted bitstream to generate a reconstructed residual block.

An entropy decoder (901) may entropy decode an input bitstream to reconstruct a quantized transform block. A reconstructed quantized transform block may be transmitted to a dequantizer (905).

A tensor entropy decoder (902) may entropy decode an input bitstream to reconstruct a quantized feature tensor. A reconstructed quantized feature tensor may be transmitted to a tensor dequantizer (903).

A tensor dequantizer (903) may dequantize an input reconstructed quantized feature tensor to reconstruct a feature tensor. In this case, if quantization using rounding was performed in a tensor quantizer (803 of FIG. 8) of a residual encoder (800 of FIG. 8), dequantization may not be performed. A reconstructed feature tensor may be transmitted to a neural network decoder (904). A neural network decoder (904) may receive a reconstructed feature tensor as input and synthesize features through multiple neural networks to generate a quantization matrix and/or an offset matrix. In this case, a quantization matrix and/or an offset matrix may have the same width and height as a reconstructed transform block. Alternatively, a width and a height may be generated to be smaller than a transform block. In this case, interpolation may be performed to be the same size as a transform block. In this case, various interpolation methods such as nearest interpolation, linear interpolation, etc. may be used. Alternatively, when a width and a height are generated to be smaller than a transform block, a quantization matrix and an offset matrix may be applied based on the top-left. A generated quantization matrix and offset matrix may be transmitted to a dequantizer (905).

A neural network encoder (802 of FIG. 8) and a neural network decoder (904) may be a neural network learned in a direction in which the sum of a prediction bit rate and an error which is a difference between an original residual block and a reconstructed residual block is reduced during a learning process. As an embodiment, a neural network encoder (802 of FIG. 8) and a neural network decoder (904) may include a neural network (or a neural network layer) learned to ensure that the sum of a prediction bit rate and an error which is a difference between an original block and a reconstructed block converges to a value smaller than (or smaller than or equal to) a predefined threshold value.

As an embodiment, an error between an original residual block and a reconstructed residual block may be the sum of absolute values of difference values between two blocks. An error between an original residual block and a reconstructed residual block may be an average value of absolute values of difference values between two blocks. Alternatively, an error between an original residual block and a reconstructed residual block may be the sum of squares of difference values between two blocks. Alternatively, an error between an original residual block and a reconstructed residual block may be an average value of squares of difference values between two blocks.

In addition, as an embodiment, a prediction bit rate may be calculated based on a probability value of coefficients in a quantized transform block. As an example, a prediction bit rate may be a value obtained by adding values obtained by taking a logarithm with a base of 2 to quantized transform block values. Alternatively, a probability value may be calculated based on a parameter obtained based on a specific probability distribution, which may be used to derive a prediction bit rate. For example, a probability value may be calculated according to a different probability distribution according to a position of a transform coefficient within a block, and the bit generation amount accordingly may be predicted. In this case, a probability distribution may follow a Gaussian distribution. Alternatively, a probability distribution may follow a Laplacian distribution. Alternatively, a probability distribution may follow a compound distribution of multiple Gaussian distributions. Alternatively, probability values may be calculated by using multiple learned parameters, and a negative value of a value obtained by taking logarithms with a base of 2 and adding them may be used as a prediction bit rate. In this case, when the sum of an error and a prediction bit rate is calculated, an error or a prediction bit rate may be scaled to match the scale of two values.

In a learning process described above, a deep learning-based optimization method such as Stochastic Gradient Descent (SGD), Adaptive Moment Estimation (Adam), Root Mean Square Propagation (RMSProp), etc. may be used as an optimization method.

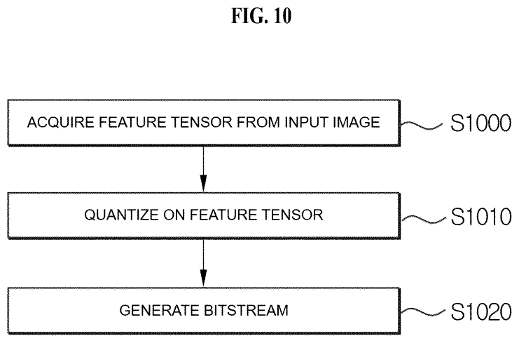

FIG. 10 is a flowchart showing a neural network-based image processing method according to an embodiment of the present invention.

In FIG. 10, a neural network-based image processing method performed by an encoder is mainly described, but a method substantially the same as or corresponding to an embodiment according to the present disclosure may be performed by a decoder. In this embodiment, the encoder may be an image encoder (100) in FIG. 1, an image encoder (200) in FIG. 2, an image encoder (400) in FIG. 4, a residual encoder (600) in FIG. 6 or a residual encoder (800) in FIG. 8, and the decoder may be an image decoder (110) in FIG. 1, an image decoder (300) in FIG. 3, an image decoder (500) in FIG. 5, a residual decoder (700) in FIG. 7 or a residual decoder (900) in FIG. 9. A method described in each embodiment may be applied equally/similarly, and an overlapping description related thereto is omitted.

Referring to FIG. 10, an encoder may obtain a feature tensor from an input image by using a first neural network including a plurality of neural network layers (S1000). An encoder may obtain a quantized feature tensor by performing quantization on the obtained feature tensor based on a quantization size (S1010).

As described above, the quantization size may be adaptively derived based on at least one of the obtained feature tensor, a target bit rate or distribution information. In this case, the distribution information may be obtained based on a distribution feature tensor, and the distribution feature tensor may be obtained from the obtained feature tensor by using a second neural network including a plurality of neural network layers. As an example, the distribution information may be obtained by using a third neural network including a plurality of neural network layers.

In addition, as described above, the quantization size may be derived by repeatedly updating the quantization size based on a backpropagated error. In this case, the error may be derived based on a difference between the target bit rate and a prediction bit rate. As an example, update for the quantization size may be repeatedly performed so that the prediction bit rate converges to the target bit rate. In addition, as an example, update for the quantization size may be repeatedly performed so that the error becomes less than or equal to a predefined threshold value. Update for the quantization size may be performed by using at least one of stochastic gradient descent, adaptive moment estimation or root mean square propagation.

In addition, as described above, the prediction bit rate may be calculated by using a probability value of values of the obtained feature tensor determined according to the distribution information. As an example, the prediction bit rate may be calculated by adding a value obtained by taking a logarithm with a base of 2 to a probability value of values of the obtained feature tensor. As an example, the error may be backpropagated by using a Straight Through Estimator (STE) method in which a differential value is fixed to a predefined value. For example, the differential value may be predefined as one of ½, 1, 2, 3 and 4.

An encoder may generate a bitstream by performing entropy encoding on the quantized feature tensor (S1020).

As described above, the bitstream may include a distribution bitstream generated by performing entropy encoding on the distribution feature tensor. In addition, as an example, the bitstream may be generated by performing Asymmetric Numeral System (ANS)-based entropy encoding on the quantized feature tensor based on a predefined probability table. In addition, as an example, the first neural network and the second neural network may be learned so that the sum of a difference between the input image and a reconstructed image and the amount of bits generated becomes smaller.

Embodiments described above may be a combination of components and features of the present disclosure in a predetermined form. Each component or feature should be considered selective unless explicitly stated otherwise. Each component or feature may be implemented in a form which is not combined with other component or feature. In addition, some components and/or features may be combined to configure an embodiment of the present disclosure. Order of operations described in embodiments of the present disclosure may be changed. Some configurations or features of an embodiment may be included in other embodiment or may be replaced with a configuration or a feature corresponding to other embodiment. It is obvious that claims without an explicit citation relationship in a scope of claims may be combined to configure an embodiment or may be included as a new claim by amendment after application.

An embodiment according to the present disclosure may be implemented by a variety of means, for example, hardware, firmware, software, or a combination thereof, etc. For implementation by hardware, an embodiment of the present disclosure may be implemented by one or more ASICs (application specific integrated circuits), DSPs (digital signal processors), DSPDs (digital signal processing devices), PLDs (programmable logic devices), FPGAs (field programmable gate arrays), processors, controllers, micro controllers, micro processors, etc.

In addition, for implementation by firmware or software, an embodiment of the present disclosure may be implemented in a form of a module, a procedure, a function, etc. performing functions or operations described above and may be recorded in a readable recoding medium through a variety of computer means. Here, a recording medium may include a program instruction, a data file, a data structure, etc. alone or in combination. A program instruction recorded in a recording medium may be those specially designed and configured for the present disclosure or those available by being notified to a person skilled in computer software. For example, a recording medium includes magnetic media such as a hard disk, a floppy disk and a magnetic tape, optical media such as CD-ROM (Compact Disk Read Only Memory) and DVD (Digital Video Disk), magneto-optical media such as a floptical disk and a hardware device which is specially configured to store and perform a program instruction such as ROM, RAM, a flash memory, etc. An example of a program instruction may include a high-level language code which may be executed by a computer by using an interpreter, etc. as well as a machine language code like what is made by a compiler. Such a hardware device may be configured to operate as at least one software module to perform an operation of the present disclosure and vice versa.

In addition, a device or a terminal according to the present disclosure may be driven by a command which causes at least one processor to perform functions and processes described above. For example, such a command may include, for example, an interpreted command like a script command such as a JavaScript or ECMAScript command, etc. or other commands stored in a computer readable medium readable or an executable code. Further, a device according to the present disclosure may be implemented in a distributed way across a network such as Server Farm or may be implemented in a single computer device.

In addition, a computer program which comes with a device according to the present disclosure and executes a method according to the present disclosure (also known as a program, software, a software application, a script or a code) may be written in any form of a programming language including a compiled or interpreted language or a priori or procedural language and may be deployed in any form including a stand-alone program, module, component or subroutine or other units suitable for use in a computer environment. A computer program does not necessarily correspond to a file of a file system. A program may be stored in a single file provided for a requested program, or in multiple interacting files (e.g., a file storing part of at least one module, subprogram or code), or in part of a file owning other program or data (e.g., at least one script stored in a markup language document). A computer program may be positioned in one site or distributed across a plurality of sites and may be deployed to be executed on one computer or multiple computers interconnected by a communication network.

It is obvious to a person skilled in the art that the present disclosure may be implemented in other specific form without departing from an essential feature of the present disclosure. Accordingly, the above-described detailed description should not be interpreted restrictively in all respects and should be considered illustrative. A scope of the present disclosure should be determined by reasonable interpretation of attached claims and all changes within an equivalent scope of the present disclosure are included in a scope of the present disclosure.

### INDUSTRIAL AVAILABILITY

The present invention may be used in neural network-based image processing methods and devices.

1. A neural network-based image processing method, comprising:
acquiring a feature tensor from an input image by using a first neural network including a plurality of neural network layers;
acquiring a quantized feature tensor by quantizing the acquired feature tensor based on a quantization size; and
generating a bitstream by performing entropy encoding on the quantized feature tensor,
wherein the quantization size is adaptively derived based on predefined encoding information.

2. The method of claim 1, wherein the quantization size is adaptively derived based on at least one of the acquired feature tensor, a target bit rate, or distribution information.

3. The method of claim 2, wherein the distribution information is acquired based on a distribution feature tensor, and
wherein the distribution feature tensor is acquired from the acquired feature tensor by using a second neural network including a plurality of neural network layers.

4. The method of claim 3, wherein the bitstream includes a distribution bitstream generated by performing the entropy encoding on the distribution feature tensor.

5. The method of claim 2, wherein the quantization size is derived by repeatedly updating the quantization size based on a backpropagated error, and
wherein the error is derived based on a difference between the target bit rate and a prediction bit rate.

6. The method of claim 5, wherein an update for the quantization size is repeatedly performed so that the prediction bit rate converges to the target bit rate.

7. The method of claim 5, wherein an update for the quantization size is repeatedly performed so that the error becomes smaller than or equal to a predefined threshold value.

8. The method of claim 5, wherein an update for the quantization size is performed by using at least one method of a stochastic gradient descent, an adaptive moment estimation, or a root mean square propagation.

9. The method of claim 5, wherein the prediction bit rate is calculated by using a probability value of values of the acquired feature tensor determined according to the distribution information.

10. The method of claim 9, wherein the prediction bit rate is calculated by adding a value obtained by taking a logarithm with a base of 2 to the probability value of the values of the acquired feature tensor.

11. The method of claim 5, wherein the error is backpropagated by using a Straight Through Estimator (STE) method in which a differential value is fixed to a predefined value.

12. The method of claim 11, wherein the differential value is predefined as one of ½, 1, 2, 3, or 4.

13. The method of claim 1, wherein the bitstream is generated by performing an Asymmetric Numeral System (ANS)-based entropy encoding on the quantized feature tensor based on a predefined probability table.

14. The method of claim 3, wherein the first neural network and the second neural network are learned so that a sum of a difference between the input image and a reconstructed image and an amount of generated bits becomes smaller.

15. A neural network-based image processing device, comprising:
a processor configured to control the image processing device; and
a memory connected to the processor, the memory being configured to store data, wherein the processor is configured to:
acquire a feature tensor from an input image by using a first neural network including a plurality of neural network layers,
acquire a quantized feature tensor by quantizing the acquired feature tensor based on a quantization size,
generate a bitstream by performing entropy encoding on the quantized feature tensor,
wherein the quantization size is adaptively derived based on predefined encoding information.
